(19) United States
(12) Patent Application Publication
(10) Pub. No.: US 2014/0318909 A1
(43) Pub. Date: Oct. 30, 2014

(54) SHOCK ABSORBER

(71) Applicant: EAB Engineering AS, Gjovik (NO)

(72) Inventor: Harald Bakke, Gjovik (NO)

(73) Assignee: EAB Engineering AS, Gjovik (NO)

(21) Appl. No.: 14/298,607

(22) Filed: Jun. 6, 2014

Related U.S. Application Data
(63) Continuation of application No. PCT/NO2012/050244, filed on Dec. 6, 2012.

(30) Foreign Application Priority Data
Dec. 6, 2011 (NO) 20111688

(51) Int. Cl. F16F 9/348

(52) U.S. Cl. CPC F16F 9/348
USPC 188/313

(57) ABSTRACT

A shock absorber for use in lowering heavy structures to the sea floor comprises a cylinder with a piston having a heavy piston rod. A plurality of channels extend from the bottom side of the piston to its top side, where the channels are closable by means of a valve body, which permits fluid movement up through the piston to a cylinder chamber above the piston, but not in the opposite direction. The cylinder chamber is provided with a plurality of exit nozzles having decreasing diameter in the direction towards the bottom of the chamber. When the piston rod impacts against its substructure on the sea floor, it will force the piston upwards in the chamber. The valve body will close the channels so that the water in the chamber has to escape mainly through the nozzles, thus giving the shock absorber the desired resisting force.

### CROSS-REFERENCE TO RELATED APPLICATIONS

This application is a continuation of International Application No. PCT/NO2012/050244, filed Dec. 6, 2012, which claims priority to Norwegian Patent Application No. 20111688, filed Dec. 6, 2011, both of which are hereby incorporated herein by reference in their entirety for all purposes.

### STATEMENT REGARDING FEDERALLY SPONSORED RESEARCH OR DEVELOPMENT

Not applicable.

### DESCRIPTION OF RELATED ART

In connection with underwater installations of heavier modules and tools in already installed structures, there is often a need for damping systems in order to prevent large dynamic impact forces due to heave movement of the installation ship.

For intervention tools, the convention is normally that it must be damped from a landing speed of 1.8 msec to 0.1 msec, while for large structures which are installed with a good heave compensating system on the crane, the convention is typically that it must be damped from 0.5 msec to 0.1 msec.

A problem with earlier damping cylinders, which generally were of the hydraulic type, was that is was difficult to make the piston return quickly enough out again in order to remain in contact with the substructure when the crane hook was subjected to a heave movement in the last phase of the lowering. This could give rise to several and possibly strong impacts before the structure came to rest on the substructure.

WO 2009/011596, which is hereby incorporated by reference, shows a damping cylinder which solves this problem and concurrently provides a shock absorber which is simple and reasonable to produce and, additionally, has a quick and reliable function. Such cylinders are built in different dimensions, the largest having a weight of the piston and piston rod of 700 kg or more.

During transportation to the installation site, the piston and piston rod are fixed in a refracted position and must therefore be released in order to assume their stand-by position before the structure, for instance a heavy module, is lowered. This release causes the piston and piston rod to fall freely until the piston stops with a violent and potentially destructive impact against the bottom of the cylinder.

The present disclosure aims at dampening such impacts, and this is obtained according to the disclosure by a shock absorber as recited in claim 1.

Advantageous embodiments of the disclosure are defined in the dependent claims.

### BRIEF DESCRIPTION OF THE DRAWINGS

For better understanding of the disclosure it will be described more closely with reference to the exemplifying embodiment illustrated in the appended drawings in which:, where all the FIGS. 1-3 show an axial section through a shock absorber according to the disclosure.

FIG. 1 is an axial section of an embodiment of a shock absorber prior to actuation in accordance with the principle described herein;

FIG. 2 is an axial section of the shock absorber of FIG. 1 during actuation; and

FIG. 3 shows an axial section of the shock absorber of FIG. 1 after actuation.

### DETAILED DESCRIPTION

The shock absorber shown in the drawings has a cylinder 1 and a piston 2 slidably arranged therein. The piston has a piston rod 3, which is solid and in the example shown has a diameter which is somewhat larger than half the diameter of the piston 2. The piston 2 with the piston rod 3 therefore has a relatively substantial weight.

The piston 2 has an upper or top portion 4 having a full diameter and a lower or bottom portion with a depending annular portion or skirt 5 surrounding the piston rod 3. A number of axial through holes 6 are present in the upper portion of the piston. These holes 6 have together a relatively large flow area. At the top, the holes 6 are covered by a valve body 7, which is constituted by an annular disk which is axially movable within limits along a guide 8 having a stopper collar 9. The disk has two O-rings 10 and 11 in order to seal against the piston 2 during an upward movement of the piston.

At the top or upper end, the cylinder 1 is closed by an upper cover 12 which is attached to the cylinder 1 by means of a weld 13.

At the bottom or lower end, the cylinder 1 has a threaded end piece 14, which closes the cylinder 1 around the piston rod 3 and forms a guide for the piston rod 3. The bottom side of the end piece 14 is provided with a substantially annular plate 15, which contains a locking pin 16 that cooperates with a semi-circular groove 17 at the lower end of the piston rod 3. The locking pin 16 has a semi-circular portion where it crosses the semi-circular groove 17 of the piston rod, so that by rotating the locking pin 16, it can retain the piston rod during transport and release it during commissioning on the installation site.

The bottom the cylinder 1 is provided with a number of inlet openings 19, which are in fluid connection with the through holes 6 in the piston 2. A chamber 20 formed inside the cylinder above the piston 2 in the lower position thereof and the upper cover 13, is provided with a plurality of exit openings 21, shown here in one axially extending row. The openings 21 have decreasing diameter in the upward direction, so that when the piston moves past the openings, the flow area of the remaining openings will be reduced in an approximately exponential manner towards an asymptotic value determined by the uppermost exit opening 21 and a ventilation opening 22 through the cover 12.

The end piece 14 of the cylinder is provided with a cavity 23 in the form of a recess or pocket, which will receive the depending portion of the skirt 5 on the piston with a given clearance when the piston is situated in its lowest position, with the piston rod 3 extending completely out of the cylinder.

In the illustrated exemplifying embodiment, the annular portion 5 has a straight cylindrical form, and the cavity 23 has a conical downwardly tapering outer delimitation. The annular portion 5 fits tightly to the piston rod 3, and the inner delimitation of the cavity 23 is formed by the piston rod 3. Other embodiments are conceivable, e.g. the skirt 5 may be tapered in the downward direction and the pocket 23 can be straight cylindrical. Besides, the skirt 5 may be arranged at a distance from the piston rod 3, so that the inner delimitation of the pocket 23 no longer will be the piston rod.

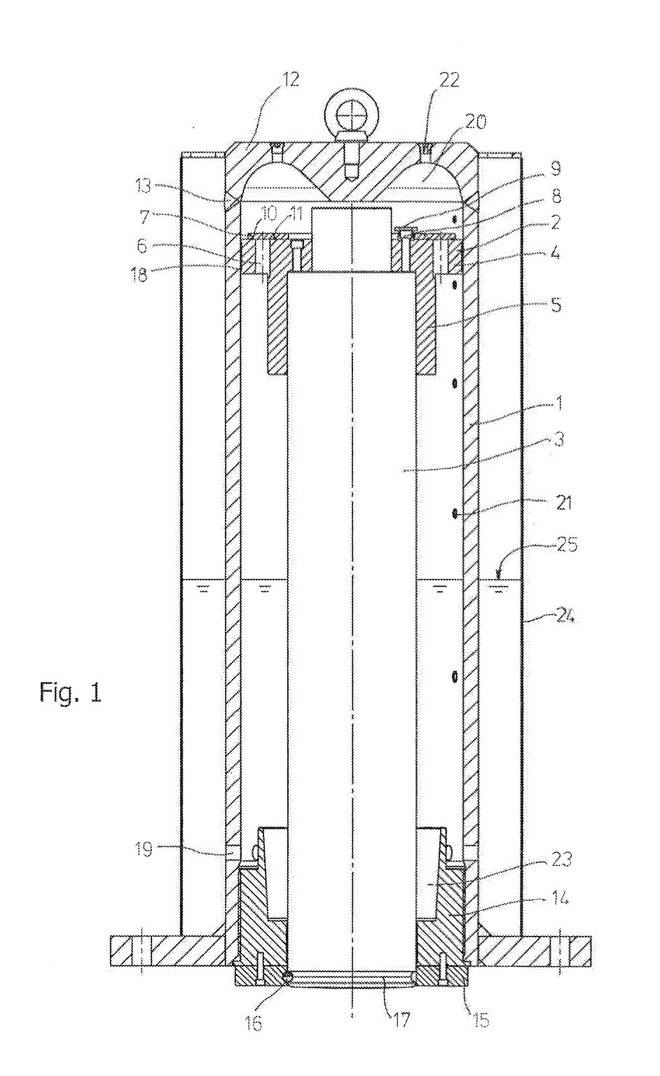

In the illustrated exemplifying embodiment, the shock absorber is provided with a casing 24, also called a bucket, which is used to fill the shock absorber and form a water reservoir for testing the shock absorber on land and in readying the shock absorber from transport position to stand-by position. FIG. 1 shows the shock absorber in a position for readying with a suitable water level 25 in the casing 24 and cylinder 1.

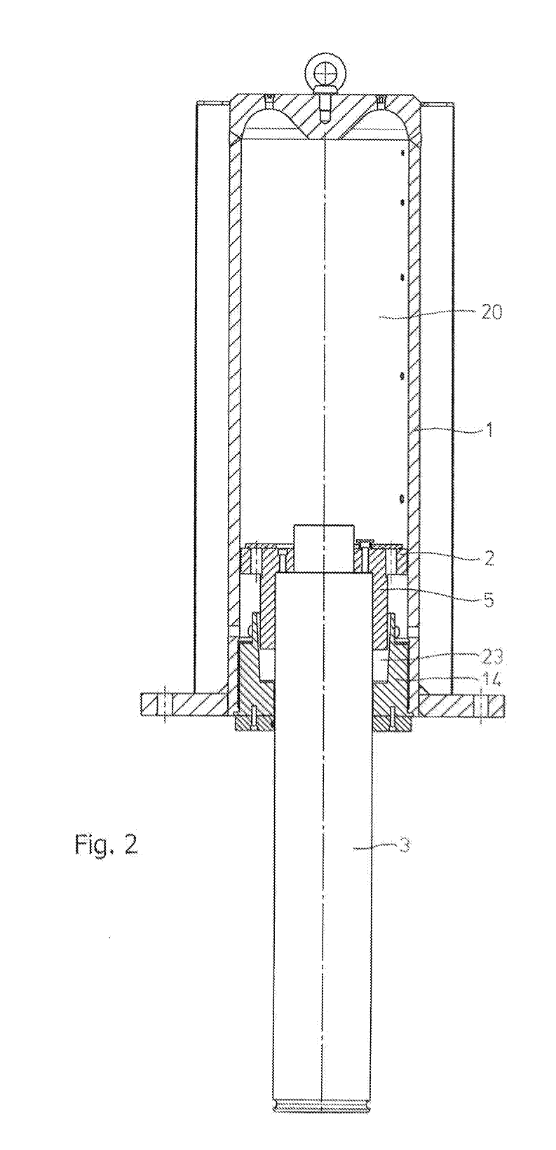

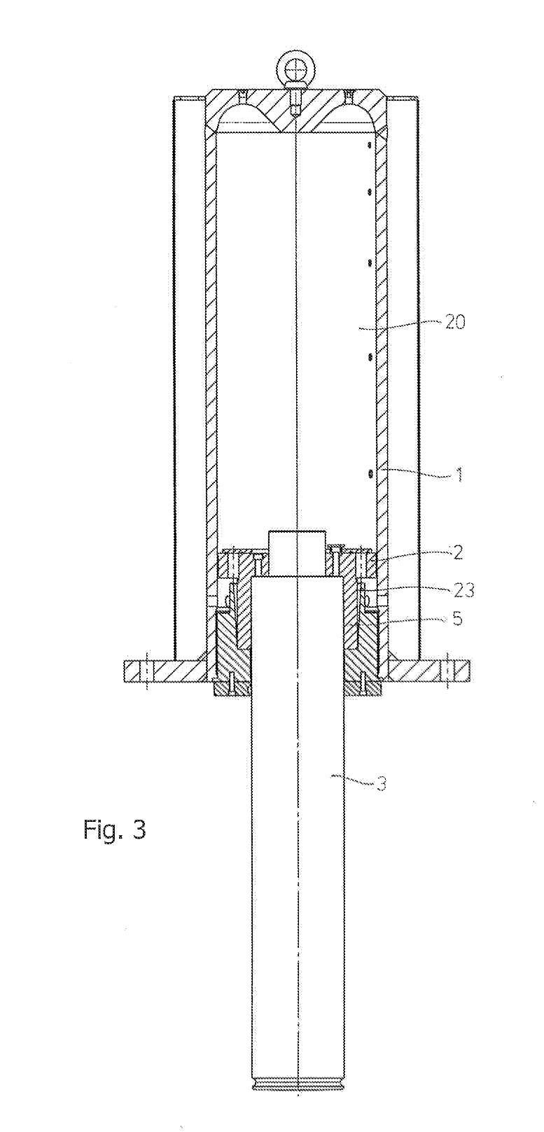

In the transport position, when the shock absorber is made ready for use, the piston rod 3 is initially refracted and locked at the bottom with a pivotable locking pin 16, shown in FIG. 1, while the cylinder 1 and the casing 24 are partly filled with water up to a suitable level 25. To make the shock absorber ready for use, by means of an operating device (not shown), the locking pin 16 is turned a quarter of a revolution counter clockwise, alternatively three quarters of a revolution clockwise, so that the lower end of the piston rod is released. The piston rod 3 with the piston 2 will fall freely due to their weight until the piston hits the water surface 25. However, this will not provide sufficient braking because the water under the piston will be forced out through the holes 6 in the piston and the openings 19 lowest in the cylinder 1. A stronger braking begins when the skirt 5 penetrates into the pocket 23 because the water in the pocket will have to flow out through a gap between the front edge of the skirt and the slightly conical wall of the pocket. This gap becomes gradually narrower as the skirt penetrates into the pocket, thereby providing an approximately even retardation of the piston and piston rod. FIG. 2 shows the situation when the skirt has penetrated about half-way into the pocket, while FIG. 3 shows the position of the parts at completion of the operation. The water levels have been left out in FIGS. 2 and 3.

During lowering of the structure to the sea floor, the piston 2 with the piston rod 3 will assume the position shown in FIG. 3. Sea water will automatically flow into the cylinder chamber 20 through the openings 19 and piston holes 6, and past the valve body 7.

When the structure suspended in a heave compensated crane on a surface vessel has come sufficiently close to its landing spot, the piston rod 3 will impact against its intended substructure and force the piston 2 upwards in the cylinder chamber 20. The valve body 7 will keep the piston closed, forcing the water on the top side thereof to exit through the exit openings or nozzles 21, thus providing the piston with the desired piston force. As the piston moves into the chamber 20 and passes the holes 21 in succession, the available flow area through the nozzles is reduced, so that the flow resistance would increase if the penetrating velocity of the piston 2 were constant. However, the penetration velocity will decrease due to the slowing of the structure, so that by suitable sizing of the nozzles 21, the penetration force will stay substantially constant during the entire penetration.

If the structure should be subjected to a heave movement before it has arrived at its final destination, the cylinder 1 of the shock absorber will move upwards together with the structure. However, the piston rod will stay in contact with the substructure because the inlet openings 19 and holes or channels 6 in the piston 2 have a sufficiently large flow area for the volume in the chamber 20 above the piston to be refilled so quickly that a sufficiently large lifting force on the piston for the piston rod to move up from the substructure will not occur. It will be understood that only a small force will be necessary to lift the valve body 7, so that the valve body will not create any noticeable flow resistance either. Therefore, the shock absorber will be ready to perform its impact dampening function once more when the structure moves downwards again.

It will be understood that the disclosure is not limited to the exemplifying embodiment described above, but may be modified and varied by the skilled person within the scope of the following claims.

1. A shock absorber for use in lowering structures to the sea floor, the shock absorber comprising:
a cylinder with a piston arranged slidable therein, said piston having a piston rod configured to extend outward out of the cylinder,
wherein at least one chamber in the cylinder above the piston is fillable with water and is configured to control discharge of the water when the piston rod is subjected to an impact force that presses the piston inward into the chamber,
wherein the water is supplied to said chamber through a valve device having a one-way function in the piston,
wherein a lower end of the cylinder is closed around the piston rod by an end piece having a cavity,
wherein a lower end of the piston has a depending annular portion having a larger outer diameter that is smaller than an inner diameter of the cylinder, and wherein the annular portion may be received with a predetermined clearance in the cavity.

2. The shock absorber according to claim 1, wherein the annular portion has a straight cylindrical form and the cavity has a conical downwardly tapering outer delimitation.

3. The shock absorber according to claim 1, wherein the annular portion fits closely to the piston rod, and the inner delimitation of the cavity is constituted by the piston rod.

4. The shock absorber according to claim 1, wherein the piston and the piston rod alone have a sufficient weight to pull the piston down and provide renewed filling of the chamber with water through the valve device when the impact force has ceased and before a new pressing in of the piston rod.

5. The shock absorber according to claim 1, wherein the at least one chamber comprises a plurality of discharge openings that are in succession made inactive by the piston moving inward into the chamber.

6. The shock absorber according to claim 5, wherein the discharge openings are arranged such that a remaining total flow area decreases approximately exponentially as the piston moves inward into the chamber.

7. The shock absorber according to claim 1, wherein the cylinder is surrounded by an upwardly open casing configured to fill the cylinder with a liquid.

8. The shock absorber according to claim 1, wherein the valve device comprises a plurality of channels through the piston, said channels being closable at an upper end of the piston by means of a valve body having a limited movement.

9. The shock absorber according to claim 8, wherein the valve body comprises an annular disk that is moveable by means of differential pressure and its own weight.

10. The shock absorber according to claim 1, wherein the piston rod is solid and has a diameter that exceeds half a diameter of the piston.
